(19) United States
(12) Patent Application Publication
(10) Pub. No.: US 2017/0124555 A1
(43) Pub. Date: May 4, 2017

(54) System for online distribution of plastic cards with unique design

(71) Applicant: László JÁGER, Nyiregyhaza (HU)

(72) Inventor: László JÁGER, Nyiregyhaza (HU)

(21) Appl. No.: 15/341,078

(22) Filed: Nov. 2, 2016

Related U.S. Application Data
(60) Provisional application No. 62/249,411, filed on Nov. 2, 2015.

(51) Int. Cl. G06Q 20/34; G06Q 30/06

(52) U.S. Cl. CPC G06Q 20/3558; G06Q 30/0621

(57) ABSTRACT

The system for online sale of uniquely designed plastic cards comprises at least one first user terminal (10) and a card-designing module (110) for creating card designs, said module being connected to said terminal via the internet (30). The system further comprises a storage (120) having a database for storing the unique card designs created by means of the card-designing module (110), said storage (120) being electronically and/or optically connected to the card-designing module (110); a card-selling module (130) for selecting one or more card designs stored in the database and for selling the plastic cards produced using the selected card designs, said card-selling module (130) being electronically and/or optically connected to the storage (120) comprising the database; and at least one second user terminal (20) connected to the card-selling module (130) via the internet (30).

This application claims priority to U.S. provisional application 62/249,411, filed Nov. 2, 2015, the disclosure of which is hereby incorporated by reference herein.

The present invention relates to a system for online sale of uniquely designed plastic cards.

Document WO 2008/115522 discloses a system for printing a gift card, wherein the user can select a card design stored in a central database by using a web application via the internet and can customize the selected card design with the use of predefined graphical elements. After the preparation of the unique card design the user can print the plastic card by means of a remote printer.

The drawback of the above solution is that the user can create an unique card design only for himself/herself, thus the system does not allow other users to access the unique card designs and the card designer cannot benefit from the sale price (as a kind of royalty) of the plastic card printed with a specific card design.

It is an object of the present invention to eliminate the drawbacks of the known online plastic card sale systems by improving them.

The above objects are achieved by providing a system for online sale of uniquely designed plastic cards, which comprises at least one first user terminal and a card-designing module for creating card designs, said module being connected to said terminal via internet, wherein the system further comprises a storage having a database for storing unique card designs created by means of a card-designing module, said storage being electronically and/or optically connected to the card-designing module; a card-selling module for selecting one or more card designs stored in the database and for the selling the plastic cards produced using the selected card designs, said card-selling module being electronically and/or optically connected to the storage comprising the database; and at least one second user terminal connected to the card-selling module via the internet.

Preferably, a delivery module and a payment module are electronically and/or optically connected to the card-selling module too.

Preferably, the card-designing module, the storage comprising the database and the card-selling module are integrated into one central card management module.

The invention will now be described with reference to the drawings, in which:

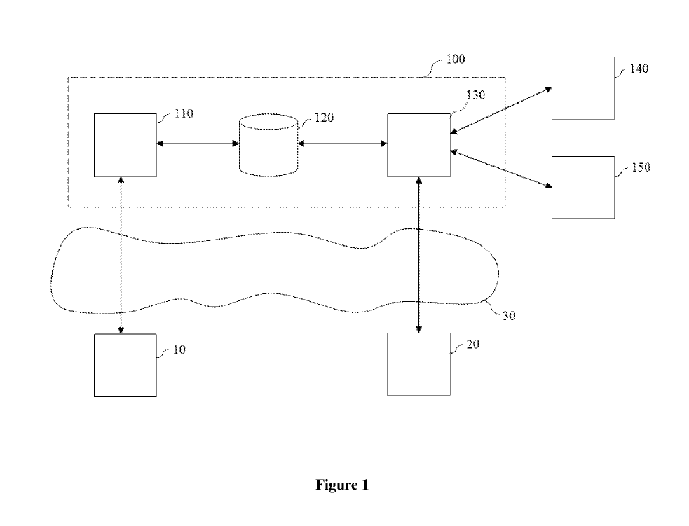

FIG. 1 schematically illustrates the system according to the present invention.

As shown in FIG. 1, a system according to the present invention comprises a central card-designing module 110, a storage 120 comprising a central database, said storage being electronically and/or optically connected to said card-designing module, and a central card-selling module 130, which is electronically and/or optically connected to the storage 120 of the central database. Preferably, the card-designing module 110, the storage 120 and the card-selling module 130 are integrated into one central card management module 100 (presented with dashed lines in FIG. 1).

At least a card-designing first user terminal 10 is connected via the internet 30 to the card-designing module 110, the user of which terminal can create a unique card design via online by means of the card-designing module 110.

The first user terminal 10 is typically a personal computer, but it can be any other processor-based means having graphical display, for example smart phone, tablet, etc., which is suitable for establishing an internet connection and can communicate with the graphical application of the card-designing module 110.

The unique card designs made by the card designing users are stored in the database of the storage 120 by means of the card-designing module 110 together with respective identification information and other parameters (e.g. with tags) facilitating their search.

A second user terminal 20 used by the users purchasing cards can connect to the card-selling module 130 via the internet 30. The second user terminal 20 is typically a personal computer, but it can be any other processor-based device having a graphical display, for example smart phone, tablet, etc., which is suitable for establishing an internet connection and can communicate with the graphical application of the card-designing module 110.

In FIG. 1 only two terminals are illustrated for the sake of simplicity, one for the first user terminal 10 and one for the second user terminal 20, however, the number of these entities may be arbitrary. Furthermore, the first user terminal 10 and the second user terminal 20, serving as components having a different function, may optionally be integrated into a single device which is configured to jointly provide said functions.

Preferably, the card-selling module 130 is electronically and/or optically connected to a delivery module 140, which prints the card design by the card purchasing users onto a plastic card by using said card-selling module 130, and delivers the card to the customer through a common delivery channel.

Preferably, the card-selling module 130 may also be electronically and/or optically connected to a payment module 150, which allows the card purchasing user to pay the price of the card design and optionally, to settle a predetermined commission for the card-designing user.

The card-designing module 110 and the card-selling module 130 may optionally belong to one central computer and preferably, this central computer further comprises the storage 120 of the database. From a practical point of view, it is particularly preferred that the graphical application of the card-designing module 110 and the card-selling module 130 is integrated into the same web application.

Now the operation of the system according to the present invention will be described.

In the first step, the card-designing user uploads, to the database stored in the storage 120, the images and the graphical elements needed for the card design, by using the graphical application of the first user terminal 10 and the card-designing module 110. Using said images and graphical elements the user creates the card design also by using the graphical application of the card-designing module 110, wherein said card design is stored also in the database of the storage 120.

The use of the card-designing application may be subject to a prior registration. Preferably, the card-designing application allows the card-designing user to modify a previously prepared card design at any time and to store it in the database of the storage 120 even as a new card design.

Due to the second user terminal 20 the card purchasing users can freely search among the card designs stored in the central database by using the online graphical application of the card-selling module 130, which provides a simple and convenient search (e.g. classification of the cards according to category, name of designer, function of card, etc.). After selecting the desired card design the card purchasing user orders the plastic card printed with a specific card design by means of the web application of the card-selling module 130.

The printing of the plastic card takes place, for example, in one or more card producing centers, card printing stores or printed by other publicly accessible printing device. Alternatively, the card purchasing user may obtain a code at order and using this code the plastic card may be produced at a later time by means of an appropriate printing device (upon accepting the code).

Sale and delivery of the ordered cards are carried out in a know way, similarly to those applied by a common web store.

When a card purchasing user orders the printing of a plastic card, the delivery may take place e.g. by regular mail or delivery service or personally at a predefined pickup point, etc.

After sending the order the card purchasing user may pay the price of the plastic card by different payment methods, e g online payment with bank card, bank transfer, payment through PayPal, and in cash in case of “cash on delivery” parcels or delivery at a pickup point.

The cards may have various functions, including, for example customer card, membership card, fan card, acknowledgement card, etc. These cards may even provide discounted shopping opportunities. (Since the cards are made only by a printing technology, they comprise no chip or magnetic stripe, therefore they cannot be used as bank cards.)

When a plastic card has an additional commercial value (e.g. smart card, discount card, loyalty card, customer card, club card, gift card, etc.), the payment module 50 forwards a portion of the card sale price, based on an agreement, to the card-issuing institution having made the card design.

The advantage of the system according to the present invention is that by means of an internet application, preferably after a registration, anybody can create an unlimited number of card designs anywhere in the world, which can be used by anyone, by means of an internet application, to order any number of plastic cards anywhere in the world.

1. A system for online sale of uniquely designed plastic cards, the system comprising at least one first user terminal (10) and a card-designing module (110) for creating card designs, said module being connected to said terminal via the internet (30),
characterized in that the system further comprises
a storage (120) having a database for storing the unique card designs created by means of the card-designing module (110), said storage (120) being electronically and/or optically connected to the card-designing module (110);
a card-selling module (130) for selecting one or more card designs stored in the database and for selling the plastic cards produced using the selected card designs, said card-selling module (130) being electronically and/or optically connected to the storage (120) comprising the database;
at least one second user terminal (20) connected to the card-selling module (130) via the internet (30).

2. The system according to claim 1, characterized in that a delivery module (140) and a payment module (150) are electronically and/or optically connected to the card-selling module (130).

3. The system according to claim 1, characterized in that the card-designing module (110), the storage (120) comprising the database and the card-selling module (130) are integrated into one central card management module (100).
